(19) United States
(12) Patent Application Publication
(10) Pub. No.: US 2013/0152001 A1
(43) Pub. Date: Jun. 13, 2013

(54) ADJUSTING USER INTERFACE ELEMENTS

(71) Applicants: Andrew William Lovitt, Redmond, WA (US); Michael Hall, Snohomish, WA (US)

(72) Inventors: Andrew William Lovitt, Redmond, WA (US); Michael Hall, Snohomish, WA (US)

(73) Assignee: Microsoft Corporation, Redmond, WA (US)

(21) Appl. No.: 13/316,101

(22) Filed: Dec. 9, 2011

(51) Int. Cl. G06F 3/048

(52) U.S. Cl. 715/765

(57) ABSTRACT

The present invention extends to methods, systems, and computer program products for adjusting user interface elements. Embodiments of the invention can adjust the size, shape, and position of user interface elements and whitespace based on historical usage data. Adjustments can reduce the cognitive load associated with selecting some user interface elements. In dangerous environments, such as, for example, a moving vehicle, reducing the cognitive load allows a user to pay attention to other matters, such as, for example, safely operating the moving vehicle. Historical usage data can originate from one or more users and one or devices. Adjustment limits can be used to insure user interfaces remain appropriately usable. User interface element adjustments can be used to optimize a user interface and/or influence user interactions with a user interface.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

On many devices, especially mobile devices and devices used in limited space areas (e.g., in vehicles), graphical interfaces are used to interact with the device. Graphical elements within a graphical interface can be selected to activate underlying functionality, such as, for example, start/close an application, play media, change volume, etc. Graphical elements can be selected in a variety of different ways, including through a touch screen, voice commands, air-gestures, physical buttons, etc. For example, touching the screen can be used to activate or close an application.

When using graphical interfaces, the amount of time it takes to select a graphical element is related to the size of the graphical element. More specifically, the amount of time it takes to select a graphical element is roughly inversely proportional to the size of the graphical element. This is due at least in part to human beings cognitive abilities and fine motor skills, which degrade with aging. As a result, larger graphical elements can be selected more quickly. On the other hand, smaller graphical elements take longer to select.

On devices having reduced screen size, such as, for example, mobile and embedded devices, it can be difficult to size graphical elements such that all graphical elements on a screen can be efficiently selected. However, in more dangerous environments, including in moving vehicles, a user's ability to efficiently interact with elements in a graphical interface is critical to the user's (as well as other's) safety. For example, it may be difficult to safely operate a graphical interface for an in-vehicle entertainment system when the graphical elements of the graphical interface are not presented with sufficient size on the screen.

### BRIEF SUMMARY

The present invention extends to methods, systems, and computer program products for adjusting user interface elements. Embodiments of the invention include altering a user interface. In some embodiments, usage information related to the user interface is accessed. The usage information describes one or more user's interactions with the elements of the user interface on one or many devices. User interface elements of interest are identified based on this usage information. It is determined that one or more of the indentified user interface elements of interest are to be adjusted to optimize user interaction with the user interface based on the usage information. The one or more identified user elements are adjusted within the user interface. Accordingly, presentation of the one or more identified user interface elements is changed on the display device.

In other embodiments, historical usage information related to the user interface is accessed. The historical usage information describes one or more user's interactions with the elements of the user interface. User interface elements of interest are identified based on the historical usage information. It is determined that one or more of the indentified user interface elements are to be adjusted to influence user interactions with the user interface based on the historical usage information. The one or more identified user interface elements are adjusted. Accordingly, the one or more user interface elements are presented more predominately on the display device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates adjusting user interface elements.

FIG. 2 illustrates a flow chart of an example method for adjusting user interface elements.

FIG. 3 illustrates an example of adjusting user interface elements.

FIG. 4 illustrates an example of adjusting user interface elements.

FIG. 5 illustrates an example of adjusting user interface elements.

FIG. 6 illustrates a flow chart of an example method for adjusting user interface elements.

FIG. 7 illustrates an example of adjusting user interface elements.

### DETAILED DESCRIPTION

The present invention extends to methods, systems, and computer program products for adjusting user interface elements. Embodiments of the invention include altering a user interface. In some embodiments, usage information related to the user interface is accessed. The usage information describes one or more user's interactions with the elements of the user interface on one or many devices. User interface elements of interest are identified from based on this usage information. It is determined that one or more of the indentified user interface elements of interest are to be adjusted to optimize user interaction with the user interface based on the usage information. The one or more identified user elements are adjusted within the user interface. Accordingly, presentation of the one or more identified user interface elements is changed on the display device.

In other embodiments, historical usage information related to the user interface is accessed. The historical usage information describes one or more user's interactions with the elements of the user interface. User interface elements of interest are identified based on the historical usage information. It is determined that one or more of the indentified user interface elements are to be adjusted to influence user interactions with the user interface based on the historical usage information. The one or more identified user interface elements are adjusted. Accordingly, the one or more user interface elements are presented more predominately on the display device.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention adjust aspects of user interface elements on a display device in order to reduce the cognitive load for interacting with devices. Embodiments of the invention can be used at devices in moving vehicles as well as at devices used in other situations where a user's attention is divided between interaction with the device and another task, such as, running or cooking. User interactions with a device can be learned and used as data to determine how to adjust user interface elements on a display device. Multiple aspects of user interactions, including context aware (or unaware), historical user interactions, per using settings, device settings, etc., can be considered when adjusting user interface elements.

Adjustments to user interface objects can include changing the size and/or positions of user interface objects (including whitespace) to optimize and/or influence subsequent user interactions with a user interface. For example, to optimize a user interface, user interface elements that are used more frequently can be moved to a more predominate position and/or size on a display device (thus reducing the cognitive load for selection). On the other hand, user interface elements that are used less frequently can be moved to a less predominate position and/or size on a display device. To influence user interactions, user interface elements can be scaled and/or positioned to make users more likely to select user interface elements based on an entity's (e.g., a content provider's) desire to have those user interface elements selected.

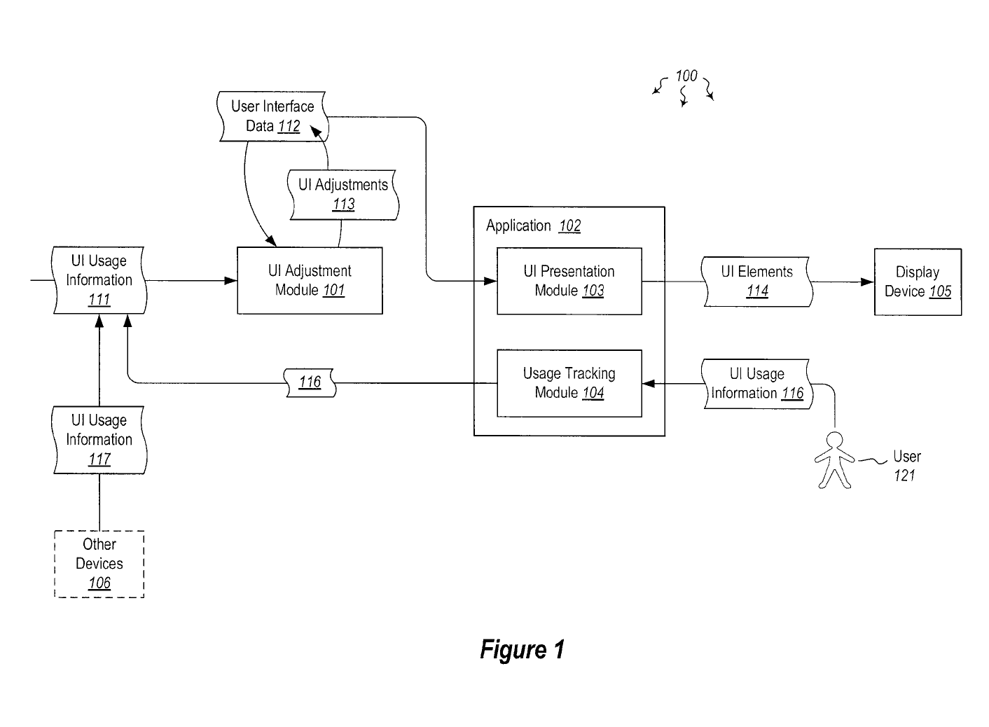

FIG. 1 illustrates an example computer architecture 100 that facilitates adjusting user interface elements. Referring to FIG. 1, computer architecture 100 includes UI adjustment module 101, application 102, display device 105, and other devices 106. Each of the depicted components is connected to one another over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

In general, UI adjustment module 101 is configured to modify user interface data for an application. User interface data can be modified based on one or more of prior, current, and expected user interaction with an application. For example, UI adjustment module 101 can access UI usage information collected for one or more users of an application at a corresponding one or more devices. UI adjustment module 101 can formulate UI adjustments for the application's user interface based on the UI usage information. UI adjustment module 101 can modify user interface data for the application in accordance with the UI adjustments.

As depicted, application 102 includes UI presentation module 103 and usage tracking module 104. Generally, UI presentation module 103 accesses user interface data for application 102 and sends corresponding UI elements to a display device for presentation. As a user interacts with application 102, usage tracking module 104 collects UI usage information for application 102. The tracked UI usage information can be stored and/or combined with UI usage information collected for other users and/or at other devices using application 102.

Display device 105 is configured to receive and present UI elements for user interfaces. Display device 105 may also receive user input, such as, for example, when display device 105 includes touch screen functionality. In other embodiments, input is received through other input devices, such as, for example, knobs, dials, push buttons, key boards, mice, etc. For example, inside a vehicle, user interface controls (either physical or touch screen) can be used to control an entertainment system, such as, to play, rewind, pause, fast forward, skip, or search media. On the other hand, on a mobile phone user interface controls (either physical or touch screen) can be used to start applications, enter data into applications, and close applications. Similarly, at a desktop or laptop computer system, user interface controls (either physical or touch screen) can be used to start applications, enter data into applications, and close applications.

Physical and virtual controls can be linked. For example, a device may have a physical play button and a touch screen play button. The physical play button and the touch screen play button can both impact user data storage in the same way. Thus, if a user presses the physical button, the virtual button on the screen adjusts as if the virtual button has been selected.

The described functionality for user interfaces at specified devices are merely examples, the described functionality can also be implemented at a variety of other devices. Further, the user interface functionality for a specified device and/or application can overlap with other devices and/or applications. Thus, different devices can run applications and interact with user interfaces for the applications using different user interface controls (either physical or touch screen).

For example, it may be that application 102, a similar application, or even a dissimilar application is run on various devices in other devices 106. Devices 106 can include modules similar to UI presentation module 103 and usage tracking module 104. As such, UI usage information for application 102, the similar application, or the dissimilar application can also be collected at other devices 106. In some embodiments, usage information from a plurality of devices is considered when adjusting user interface elements.

Accordingly, in some embodiments, user interface elements at one application are adjusted based on usage information for a user interface at another application (either at the same device or a different device). For example, touch screen buttons on a radio application in a car can be adjusted based on usage information from a media player application at a desktop computer system.

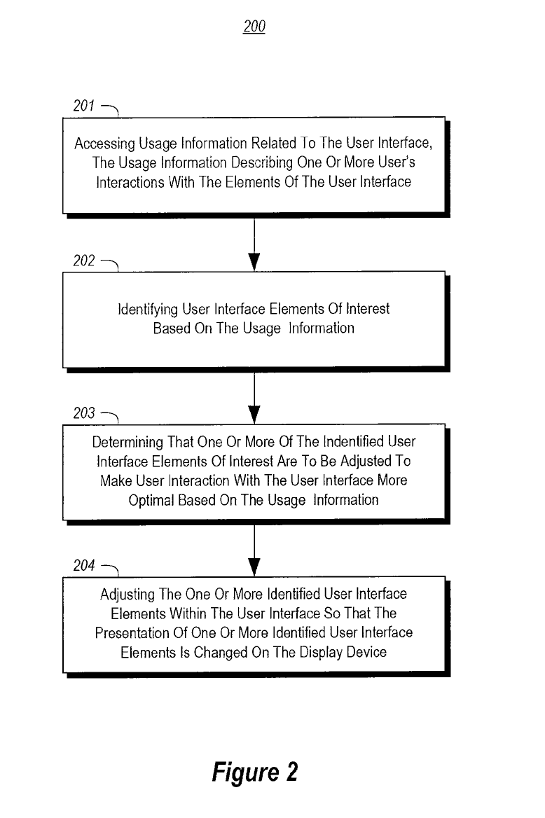

FIG. 2 illustrates a flow chart of an example method 200 for adjusting user interface elements. Method 200 will be described with respect to the components and data of computer architecture 100.

Method 200 includes an act of accessing usage information related to the user interface, the usage information describing one or more users' interactions with the elements of the user interface (act 201). For example, UI adjustment module 101 can access UI usage information 111 and user interface data 112. User interface data 112 can include user interface elements for application 102. UI usage information 111 can describe user interactions with elements in user interface data 112. UI usage information 111 can include historical information collected during prior interaction with user interface elements. Alternately or in combination, UI information 111 can include feedback collected during a current interaction user interface elements.

In some embodiments, UI usage information 111 describes the interactions of a single user (e.g., user 121). In other embodiments, UI usage information 111 describes the interactions of a plurality of users (e.g., user 121 as well as one or more users of other devices 106). For example, UI usage information 111 can include UI usage information 117 from other devices 106.

User interface data 112 can include any of a variety of different types of structural user interface elements and/or interaction user interface elements. Structural user interface elements can include windows, menus, icons, controls (widgets), and tabs. Interaction user interface elements can include cursors, pointers, adjustment handles (e.g., used for drag and drop), and selections.

Windows can include container windows, browser windows, text terminal windows, child windows, and dialog boxes. Menus can include context menus (e.g., revealed by pressing a right mouse button) and can have a menu bar and/or menu extras. Controls can include pointers, text boxes, buttons, hyperlinks, drop-down lists, list boxes, combo boxes, check boxes, radio buttons, cycle buttons, grids, and sliders.

Method 200 includes an act of identifying user interface elements of interest based on the usage information (act 202). For example, UI adjustment module 101 can identify user interface elements of interest from within user interface data 112 based on usage information 111. UI adjustment module 111 can identify user interface elements of interest based on one or more of: frequency of selection, device/manufacturer settings, user preferences, context (e.g., operating environment, weather, time, date, etc), etc.

Method 200 includes an act of determining that one or more of the indentified user interface elements of interest are to be adjusted to make user interaction with the user interface more optimal based on the usage information (act 203). For example, UI adjustment module 101 can determine that one or more of the identified user interface elements from user interface data 112 are to be adjusted. The user interface adjustments can make user interaction with a user interface for application 102 more optimal based on UI usage information 111.

Determining that a user interface element is to be adjusted to make user interaction more optimal can include determining that portion of white space or text is to be adjusted. Optimizing adjustments to user interface elements can include adjusting visual characteristics of user interface elements and text, such as, for example, size, shape, position, and color. Optimizing adjustments to whitespace can include adjusting the size, shape, position of white space.

Method 200 includes an act of adjusting the one or more identified user interface elements within the user interface so that the presentation of one or more identified user interface elements is changed on the display device (act 204). For example, UI adjustment module 101 can formulate UI adjustments 113. UI adjustments 113 can define adjustments to one or more of: size, shape, position, color and Z-ordering for the identified user interface elements in user interface data 112. UI adjustment module 101 can integrate UI adjustments 113 into user interface data 112 to adjust the identified use interface elements. UI adjustments 113 can optimize the presentation of the identified user interface elements at display device 105.

Optimizing adjustments to a user interface can include reducing the cognitive load associated with selecting more frequently selected icons. For example, an icon that is selected more frequently can be made larger, moved to the center of the screen, changed to a more dominate color, etc. to make selecting the icon more efficient. Conversely and/or to compensate, an icon that is selected less frequently can be made smaller, moved away from the center of the screen, changed to a less dominate color, etc.

In some embodiments, limiting adjustments are made to at least one user interface element in accordance with a policy. Limiting adjustments can be used to prevent or mitigate adjustments that would otherwise detract from the usability of a user interface. For example, a policy can limit the maximum size of an icon to prevent a single icon from taking up more than a specified amount of space on a user interface. On the other hand, a policy can limit the minimum size of an icon to prevent icons from becoming so small they are imperceptible to a user or from being deleted. Other polices can be used to limit adjustments to the shape and/or position of icons. Policies can be implemented based on user, device, manufacturer, context, etc.

UI adjustment module 101 can send user interface data 112 to application 102. UI presentation module 103 can receive user interface data 112 from UI adjustment module 101. UI presentation module 103 can send UI elements 114 to display device 105 for presentation. Display device 105 can receive UI elements 114 and present a user interface based on UI elements 114 (and that reflects UI adjustments 113).

User 121 can interact with the user interface. As user 121 interacts with the user interface, usage tracking module 104 can collect UI usage information 116 for user 121. Usage tracking module 104 can integrate UI usage information 116 back into UI usage information 111. UI adjustment module 101 can then determine further UI adjustments taking UI usage information 116 into account.

In some embodiments, historical information used to adjust user interface elements decays over time. Thus, as a user's behavior changes, user interface elements can be adjusted to correspond to the changed behavior.

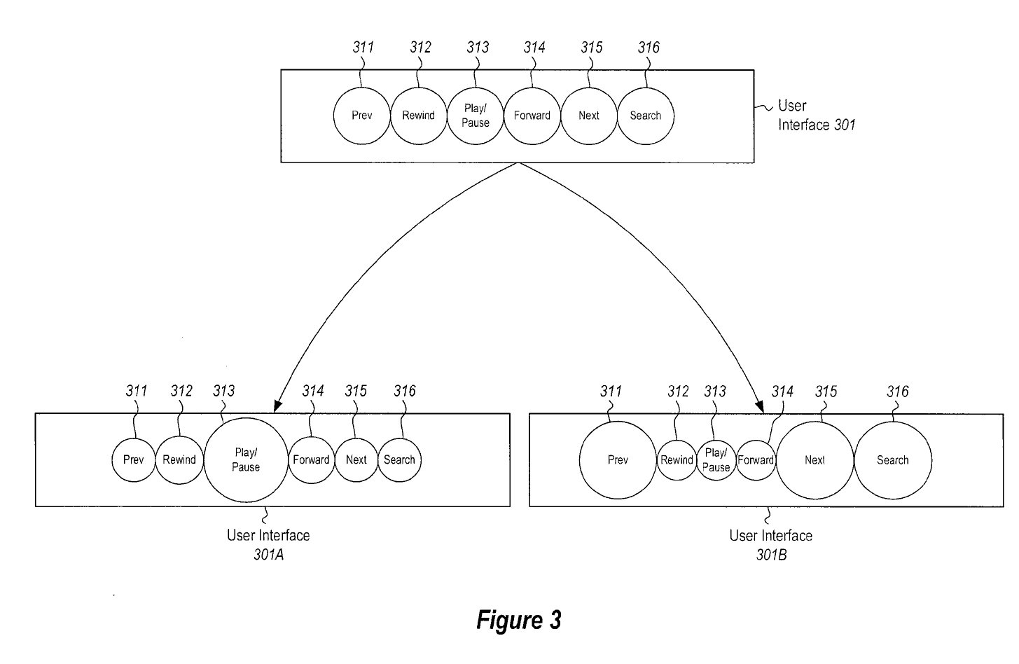

Referring now to FIG. 3, FIG. 3 illustrates example user interface screens 301, 301A, and 301B. User interface screens 301, 301A, and 301B can represent a media playing graphical user interface (e.g., for a car, phone, desktop, etc.). User interface screen 301 depicts essentially equally sized controls 311-316 for playing media.

User interface screen 301A depicts user interface adjustments increasing the size of ‘play/pause’ control 313 and decreasing the size of other controls 311, 312, and 314-316. User interface screen 301A can result from a user that selects ‘play/pause’ control 313 with increased frequency relative to the other controls 311, 312, and 314-316. Based on the usage pattern for the user, UI adjustment module 101 can learn that the user often selects ‘play/pause’ control 313. In response, UI adjustment module 101 can integrate UI adjustments into the user interface data for user interface screen 300. The UI adjustments increase the size of ‘play/pause’ control 313 and decrease the size of other controls in user interface screen 301A. Inside a vehicle, the increased predominance of ‘play/pause’ control 313 reduces the cognitive load associated with selecting ‘play/pause’ control 313 relative to the arrangement in user interface screen 300.

User interface screen 301B depicts user interface adjustments increasing the size of ‘previous’ control 311, ‘next’ control 315, and ‘search’ control 316 and decreasing the size of other controls 312-314. User interface screen 301B can result from a user that frequency switches between different media (e.g., songs). Based on the usage pattern for the user, UI adjustment module 101 can learn that the user often switches between different media. In response, UI adjustment module 101 can integrate UI adjustments into the user interface data for user interface screen 300. The UI adjustments increase the size of ‘previous’ control 311, ‘next’ control 315, and ‘search’ control 316 and decrease the size of controls 312-314. Inside a vehicle, the increased predominance of play/pause control 313 reduces the cognitive load associated with selecting ‘previous’ control 311, ‘next’ control 315, and ‘search’ control 316 relative to the arrangement in user interface screen 300.

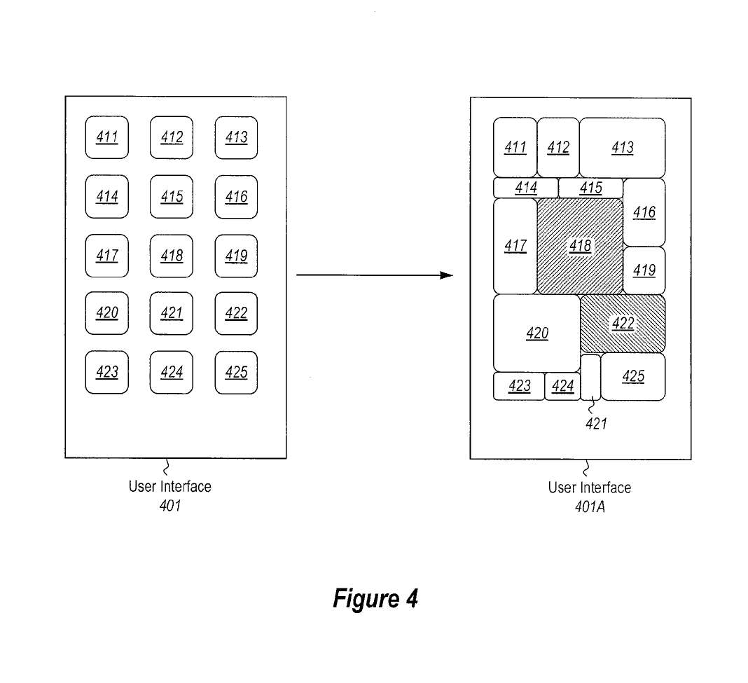

Referring now to FIG. 4, FIG. 4 illustrates example user interface screens 401 and 401A. User interface screens 401 and 401A can represent a screen of selectable objects (e.g., installed applications). User interface screen 401 can be an initial screen and user interface screen 401A an augmented screen. User interface screen 401 depicts essentially equally sized and spaced elements 411-425.

User interface screen 401A depicts user interface adjustments changing the size and spacing of elements 411-425. The color of elements 418 and 422 are also changed (indicated by the hatching). Based on a user usage pattern for selecting elements from user interface 401, UI adjustment module 101 can learn that some elements are selected more frequently or at specified times. In response, UI adjustment module 101 can integrate UI adjustments into the user interface data for user interface screen 400.

The UI adjustments rearrange the size of elements 411-425 to match the user usage pattern. The UI adjustments also change the color of elements 418 and 422. The color for element 422 can indicate that the user typically selects element 422 at the current time. The color for element 418 can indicate an alert (e.g., a system alert) for the application corresponding to element 422. Element 418 can also be a larger size based on the alert and without the user having used the application before.

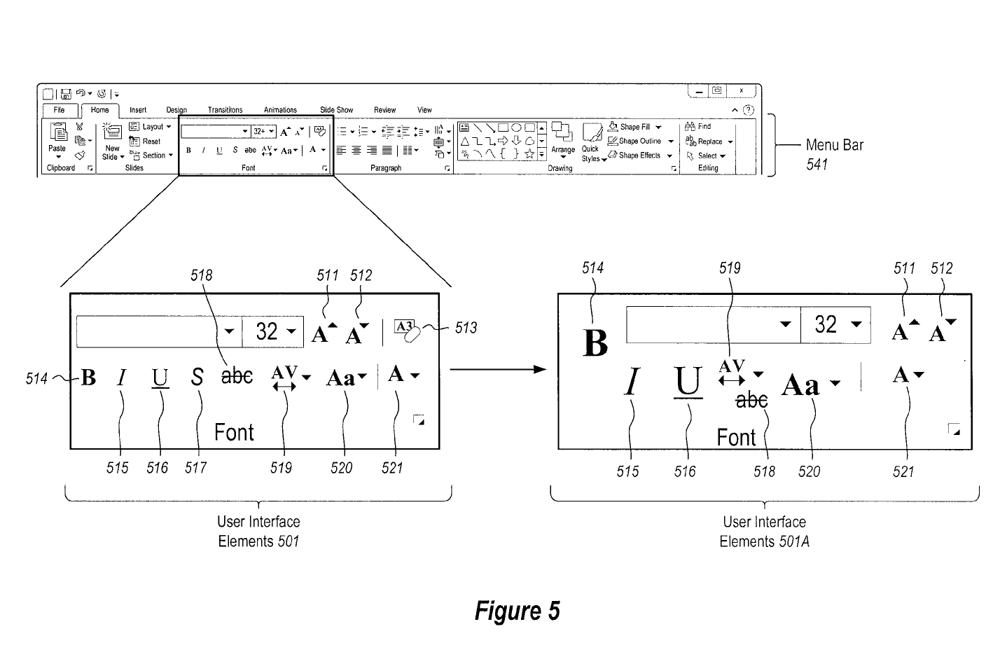

Referring now to FIG. 5, FIG. 5 illustrates example user interface screens including menu bar 541, user interface elements 501, and user interface elements 501A. User interface elements 501 and 501A can represent a screen of selectable objects 511-521 (e.g., text adjustments options). User interface elements 501 can be a default organization of text adjustment options.

User interface screen 501A depicts user interface adjustments changing the size and spacing of objects 511, 512, 514-516, and 518-521 and removing objects 513 and 518. Based on historical and contextual information, UI adjustment module 101 can learn selected objects 511-521 are accessed. In response, UI adjustment module 101 can integrate UI adjustments into the user interface data for user interface elements 500.

The UI adjustments can relocate and increase the size of selectable object 514 (e.g., the bold option). The UI adjustments can remove selectable objects 513 and 517. The UI adjustments change the size and location of various other selectable objects as well. The depicted adjustments can be further augments or supplanted by an operating context. For example, if a corporate document is being created, selectable object 514 (bold) may be more predominate. On the other hand, if a letter is being created, selectable objects 515 (italics) may be more predominate.

In some embodiments, user interface elements are adjusted more specifically to influence user interactions with a user interface. To influence user interactions, the predominance of user interface elements can be changed.

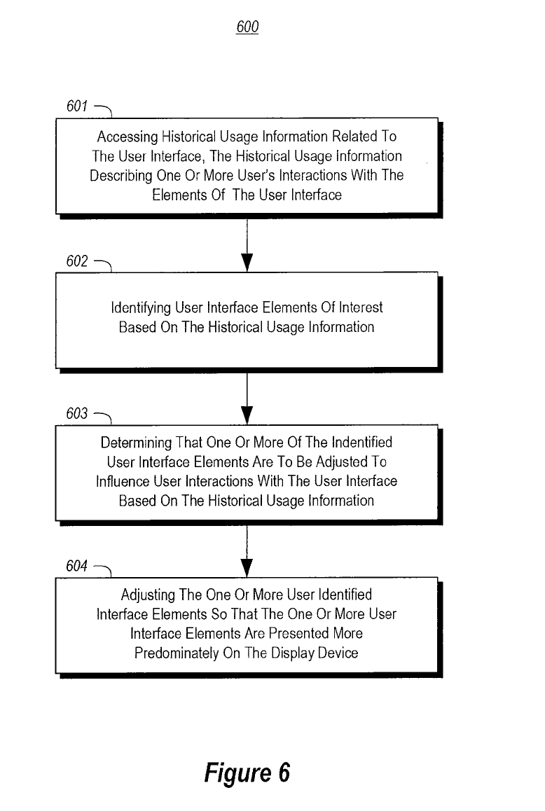

Referring now to FIG. 6, FIG. 6 illustrates a flow chart of an example method 300 for adjusting user interface elements. Method 600 will be described with respect to the components and data of computer architecture 100.

Method 600 includes an act of accessing historical usage information related to the user interface, the historical usage information describing one or more user's interactions with the elements of the user interface (act 601). For example, UI adjustment module 101 can access UI usage information 111 and user interface data 112. User interface data 112 can include user interface elements for application 102. UI usage information 111 can describe historical user interactions with elements in user interface data 112 collected during prior interaction with user interface elements. For example, UI usage information 111 can indicate that icons representing some resources are selected more frequently than icons representing other resources.

Method 600 includes an act of identifying user interface elements of interest based on the historical usage information (act 602). For example, UI adjustment module 101 can identify user interface elements of interest from within user interface data 112 based on frequency of selection. User interface elements of interest can correspond to resources that are selected with a frequency that exceeds or falls below specified thresholds.

Method 600 includes an act of determining that one or more of the indentified user interface elements are to be adjusted to influence user interactions with the user interface based on the historical usage information (act 603). For example, UI adjustment module 101 can determine that one or more of the identified user interface elements from user interface data 112 are to be adjusted. The user interface adjustments can influence user interaction with a user interface for application 102 based on UI usage information 111. For example, determined adjustments can be used to make some icons more predominate and other icons less predominate.

Method 600 includes an act of adjusting the one or more user interface elements so that the one or more user interface elements are presented more predominately on the display device (act 604). For example, UI adjustment module 101 can formulate UI adjustments 113. UI adjustments 113 can define adjustments to one or more of: size, shape, position, color and Z-ordering for the identified user interface elements in user interface data 112. UI adjustment module 101 can integrate UI adjustments 113 into user interface data 112 to adjust the identified use interface elements. UI adjustments 113 can change the predominance of user interface elements at display device 105.

For example, an icon can be made larger, moved to the center of the screen, changed to a more dominate color, etc. to increase the predominance of the user interface element when presented at display device 105. Conversely and/or to compensate, another icon can be made smaller, moved away from the center of the screen, changed to a less dominate color, etc. to decrease the predominance of the user interface element when presented at display device 105.

Embodiments of the invention can be used to balance usage of underlying hardware. For example, icons representing heavily utilized resources can be decreased in predominance and/or icons representing lightly utilized resources can be increased in predominance. The change in predominance can influence a user to select icons for lightly utilized resources and can influence the user to refrain from selecting icons for heavily utilized resources. Specified thresholds can be set to define usage patterns that trigger changing the predominance of icons.

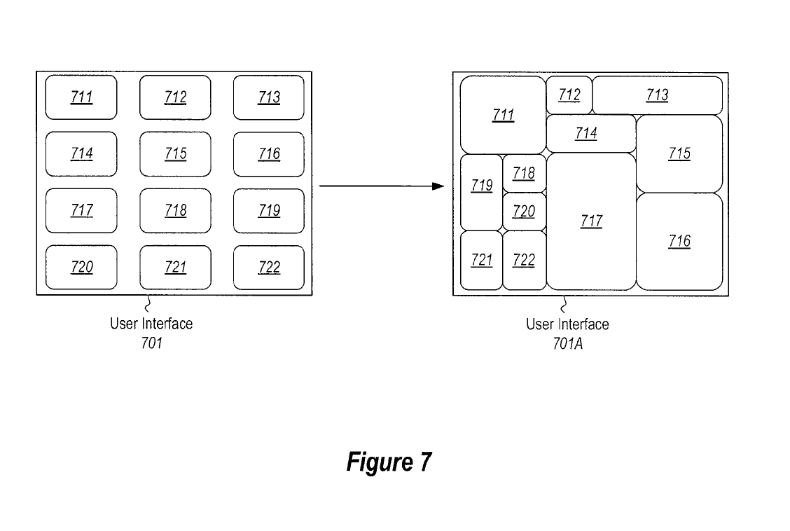

Referring now to FIG. 7, FIG. 7 illustrates example user interface screens 701 and 701A. User interface elements 701 and 701A can represent a screen of selectable objects (e.g., videos). User interface screen 701 can be an initial screen and user interface screen 701A an augmented screen. User interface screen 701 depicts essentially equally sized and spaced elements 711-722.

User interface screen 701A depicts user interface adjustments changing the size and spacing of elements 711-722. Based on a Website owners desire to have users select specified selectable objects, UI adjustment module 101 can integrate UI adjustments into the user interface data for user interface screen 700. The UI adjustments rearrange the size and position of elements 711-722 to match the Website owner's desire. As depicted, elements 711, 717, 716, 715, and to a lesser extent element 713 are more graphically dominate. For example, as usage of particular video streams changes, the Website owner can adjust predominance in real-time to influence users to selected less popular videos and thus balance usage of underlying resources.

Accordingly, embodiments of the invention can adjust the size, shape, and position of user interface elements and whitespace based on historical usage data. Adjustments can reduce the cognitive load associated with selecting some user interface elements. In dangerous environments, such as, for example, a moving vehicle, reducing the cognitive load allows a user to pay attention to other matters, such as, for example, safely operating the moving vehicle. Historical usage data can originate from one or more users and one or devices. Adjustment limits can be used to insure user interfaces remain appropriately usable. User interface element adjustments can be used to optimize a user interface and/or influence user interactions with a user interface.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. At a computer system, the computer system including a processor, system memory, and a display device, a method for adjusting user interface elements of a graphical user interface, the method comprising:
an act of accessing usage information related to the graphical user interface, the usage information describing one or more user's past interactions with one or more user input elements of the graphical user interface as well as one or more user's past interactions with one or more physical input devices that are each linked with a corresponding one of the one or more user input elements of the graphical user interface;
an act of identifying at least one user input element of interest based on the usage information, including identifying the at least one user input element of interest based on frequency of the past user interaction with the corresponding one of the one or more physical input devices;
an act of determining that the identified at least one user input element of interest is to be visually adjusted to make future user interaction with the at least one user input element at the user interface more optimal based on the usage information; and
an act of adjusting the identified at least one user input element within the user interface so that the presentation of the identified at least one user input element is emphasized relative to one or more other user input elements on the display device.

2. The method as recited in claim 1, wherein the act of accessing usage information related to the graphical user interface comprises an act of accessing historical information about user interaction with the graphical user interface.

3. The method as recited in claim 1, wherein the act of accessing usage information related to the graphical user interface comprises an act of accessing historical information for a user interface used at one or more other different computing devices.

4. The method as recited in claim 1, wherein the act of accessing usage information related to the graphical user interface comprises an act of accessing user feedback during use of the graphical user interface.

5. The method as recited in claim 1, wherein the act of accessing usage information related to the graphical user interface comprises an act of accessing usage information for a similar but different graphical user interface, the similar but different user graphical interface running at one of: the computer system or a different device.

6. The method as recited in claim 1, wherein the act of determining that the identified at least one user input element of interest is to be visually adjusted comprises an act of determining that one or more of: an application icon, a bitmap, a button, a slider, a check box, a text box, and a combo box, is to be adjusted.

7. The method as recited in claim 1, wherein the act of determining that the identified at least one user input element of interest is to be visually adjusted comprises an act of determining that a portion of white space is to be adjusted.

8. The method as recited in claim 1, wherein the act of determining that the identified at least one user input element of interest is to be visually adjusted comprises an act of determining that an element is to be adjusted, the adjustment selected from among adjusting size, shape, position, color, and Z-order.

9. The method as recited in claim 1, wherein the act of adjusting the identified at least one user input element comprises an act of adjusting one or more of the: size, shape, position, and color of an element.

10. The method as recited in claim 1, wherein the act of adjusting the identified at least one user input element comprises an act of limiting adjustments to at least one user interface element in accordance with a policy.

11. The method as recited in claim 1, wherein the act of adjusting the identified at least one user input element within the user interface so that the presentation of the identified at least one user input element is emphasized relative to one or more other user input elements on the display device comprises an act of changing the predominance of a user interface element presented at the display device.

12. The method as recited in claim 1, wherein the act of adjusting the identified at least one user input element within the user interface so that the presentation of the identified at least one user input element is emphasized relative to one or more other user input elements on the display device comprises an act of changing the visual characteristics of the one or more identified user interface elements.

13. The method as recited in claim 1, wherein the elements of the user interface include one or more of: text, images, and icons.

14. A computer system, including:
a processor,
system memory,
a display device,
one or more physical input devices, and
one or more computer readable media having stored thereon computer-executable instructions that, when executed by the processor, cause the computer system to implement a method for adjusting user interface elements of a graphical user interface, the method comprising:
an act of accessing historical usage information related to the graphical user interface, the historical usage information describing one or more user's past interactions with one or more user input elements of the graphical user interface as well as one or more user's past interactions with the one or more physical input devices, the one or more physical input devices each being linked with a corresponding one of the one or more user input elements of the graphical user interface;
an act of identifying at least one user input element of interest based on the historical usage information, including identifying the at least one user input element of interest based on frequency of the past user interaction with the corresponding one of the one or more physical input devices;
an act of determining that the identified at least one user input element is to be visually adjusted to influence future user interactions with the at least one user input element at the graphical user interface based on the historical usage information; and
an act of adjusting the identified at least one user input element so that the identified at least one user input element is visually presented more predominately on the display device relative to one or more other user input elements.

15. The computer system as recited in claim 14, wherein the act of identifying at least one user input element of interest based on the historical usage information comprises an act of identifying user interface elements representing underutilized resources.

16. The computer system as recited in claim 15, wherein the act of adjusting the identified at least one user input element so that the identified at least one user input element is visually presented more predominately on the display device relative to one or more other user input elements comprises an act of changing the size of the user interface elements to influence users to select the user interface elements representing underutilized resources.

17. A computer program product for use at a computer system, the computer system including a display device, the computer program product for implementing a method for adjusting user interface elements of a graphical user interface, the computer program product comprising one or more computer storage devices having stored thereon computer-executable instructions that, when executed at a processor, cause the computer system to perform the method, including the following:
access usage information related to the graphical user interface, the usage information describing a plurality of user's past interactions with one or more user input elements of the graphical user interface at a corresponding plurality of devices as well as one or more user's past interactions with one or more physical input devices that are each linked with a corresponding one of the one or more user input elements of the graphical user interface;
identify at least one user input element of interest based on the usage information, including identifying the at least one user input element of interest based on frequency of the past user interaction with the corresponding one of the one or more physical input devices;
determine that one or more of the size, shape, or position of one or more of the identified at least one user input element of interest is to be visually adjusted to make future user interaction with the at least one user input element at the user interface more optimal based on the usage information; and
adjusting one or more of the size, shape, or position of the identified at least one user input element within the graphical user interface so that the predominance of that identified at least one user input element is changed on the display device relative to one or more other user input elements.

18. The computer program product as recited in claim 17, wherein computer-executable instructions that, when executed, cause the computer system to access usage information related to the graphical user interface comprise computer-executable instructions that, when executed, cause the computer system to accessing user feedback during use of the graphical user interface.

19. The computer program product as recited in claim 17, wherein computer-executable instructions that, when executed, cause the computer system to determine that one or more of the size, shape, or position of the identified at least one user input element of interest is to be visually adjusted comprise computer-executable instructions that, when executed, cause the computer system to determine that a portion of white space is to be adjusted.

20. The computer program product as recited in claim 17, wherein computer-executable instructions that, when executed, cause the computer system to identify at least one user input element of interest based on the usage information comprise computer-executable instructions that, when executed, cause the computer system to identify a user interface element representing underutilized resources.
